(19) United States
(12) Patent Application Publication
(10) Pub. No.: US 2012/0213398 A1
(43) Pub. Date: Aug. 23, 2012

(54) SPEAKER, AND ELECTRONIC APPARATUS AND CELLULAR PHONE USING THE SPEAKER

(75) Inventors: Satoshi Itoh, Mie (JP); Takehiko Tanabu, Mie (JP); Mitsukazu Kuze, Mie (JP); Masashi Kawabe, Mie (JP); Tatsuya Nishimoto, Mie (JP)

(73) Assignee: Panasonic Corporation, Osaka (JP)

(21) Appl. No.: 13/504,217

(22) PCT Filed: Oct. 27, 2010
(86) PCT No.: PCT/JP10/06336

§ 371 Date: Apr. 26, 2012

(30) Foreign Application Priority Data
Oct. 29, 2009 (JP) 2009-248720
Dec. 28, 2009 (JP) 2009297403

(51) Int. Cl. H04R 9/06; H04R 1/02

(52) U.S. Cl. 381/334; 381/398; 381/332

(57) ABSTRACT

A speaker includes a magnetic circuit, frame, diaphragm, voice coil, and terminals. The frame has an opening and is coupled to the magnetic circuit, and includes a resin portion. The diaphragm is coupled to a rim of the opening of the frame. The voice coil includes lead wires and is coupled to the diaphragm, and a part of the voice coil is disposed at a magnetic gap of the magnetic circuit. The terminals are coupled to the frame by insert-molding. An outer shape formed of the frame and the terminals is one of a rectangle or a square. The resin portion of the frame has cut-away sections at corners of its outer shape.

The terminals include protruding sections protruding from the cut-away sections, and the lead wires of the voice coil are connected to the protruding sections.

### TECHNICAL FIELD

The present invention relates to a speaker to be used in various audio devices and portable phones, and it also relates to an electronic device and a portable phone using the same speaker.

### BACKGROUND ART

In recent years, portable electronic devices such as a compact audio device or a portable phone have been sophisticated, and on top of that, the market requires those devices to be further downsized for better usability and portability. A small size speaker to be used in those portable devices is required from the market to be still more downsized.

One answer to this requirement, particularly for a speaker to have a smaller size, is to reduce an area of diaphragm; however, this is not a good idea in terms of maintaining a sound pressure of the speaker. Another answer to this requirement is to adopt a shape of rectangle, square, or racetrack as an outer shape of the speaker. This idea makes the speaker more suitable for being mounted to the portable electronic devices.

On the other hand, although the requirement, particularly for a speaker having a thinner body, is encountered with difficulty in designing an input-withstanding, the thinner body does not involve the reduction in the area of diaphragm, and it can be mounted with ease to the portable devices. The thinner body has been thus strongly required from the market.

A conventional small speaker used in a portable phone is taken as an example and described hereinafter. FIG. 8 is a plan view of this small speaker, and FIG. 9 is a sectional view thereof. This speaker includes magnetic circuit 4, resin frame 6, diaphragm 7, voice coil 8, and terminals 10. Since diaphragm 7 is made of transparent material, the plan view cannot show it but what is below diaphragm 7 can be seen-through instead.

Magnetic circuit 4 of inner magnet type is formed by connecting magnet 1 and upper plate 2 to yoke 3. Yoke 3 and terminals 10 are insert-molded into resin frame 6. Voice coil 8 is inserted into magnetic gap 5 of magnetic circuit 4. Lead wires 11 of voice coil 8 are routed to and electrically connected to terminals 10 at the rear side of diaphragm 7, which is bonded to a rim of an opening of resin frame 6 and voice coil 8. The foregoing speaker is disclosed in, e.g. Patent Literature 1.

As discussed above, the speaker is formed by mounting the respective components on top of each other, so that the total height is determined by a total thickness of each component and amplitude strokes of vibrating components. The following components are involved in the determination of the total height: thickness of magnetic circuit 4 and resin frame 6; thickness of terminal 10 disposed on resin frame 6; outer diameter of lead wire 11 disposed on terminal 10 of voice coil 8; thickness of solder that bonds terminal 10 to lead wire 11 of voice coil 8; thickness of reinforcing agent that covers and reinforces the soldered section; amplitude stroke between the reinforcing agent and diaphragm 7; and thickness of diaphragm 7. In the case where diaphragm 7 needs to be protected, amplitude stroke between the protector and diaphragm 7 and thickness of the protector should be counted.

As discussed above, various types of components and amplitude strokes must be taken into consideration before the total height of the speaker is determined. It is thus difficult to achieve the thinner body that can meet the market requirement.

### CITATION LIST

Patent Literature 1: Japanese Patent Laid-Open Publication No.: 2009-267906

### DISCLOSURE OF INVENTION

The present invention aims to provide a speaker that can be mounted appropriately to a portable electronic device with ease and achieve a thinner body. The speaker of the present invention comprises the following structural elements a magnetic circuit including a magnet, a frame. a diaphragm, a voice coil. and a terminal. The frame has an opening, a resin section, and is coupled to the magnetic circuit. The diaphragm is coupled to a rim of an opening of the frame. The voice coil has lead wire, and is coupled to the diaphragm. A part of the voice coil is disposed in a magnetic gap formed somewhere in the magnetic circuit. The terminal is insert-molded with the frame, and is coupled to the frame. The outer shape formed of the frame and the terminal forms a rectangle or a square viewed from the diaphragm side. A corner of the outer shape of the resin section of the frame have a cut-away section from which the terminal protrude, and the lead wire of the voice coils is coupled to the terminal at the protruding section.

The junction between the terminal and the lead wire of the voice coil is placed outside the diaphragm, so that this structure allows excluding the thickness of the following components from the total height of the speaker: such as the thickness of the terminal, the outer diameter of the lead wire, and the thickness of the binding member, e.g. solder, for coupling these members together. The speaker can be thus thinned by the dimensions of these components, and yet, the terminal has the section protruding from a side wall of the cut-away section of the outer shape of the frame, and the protruding section can stay within an outer shape of the speaker. Since the protruding section is coupled to the lead wire of the voice coil, an outer dimension of the speaker falls within the rectangle or the square. As a result, this speaker can be mounted appropriately to electronic devices with ease.

### BRIEF DESCRIPTION OF DRAWINGS

FIG. 1 is a plan view of a speaker in accordance with a first embodiment of the present invention.

FIG. 2 is a sectional view of the speaker shown in FIG. 1.

FIG. 3 is a plan view of a speaker in accordance with a second embodiment of the present invention, and this speaker is in progress of assembly.

FIG. 4 is a plan view of a speaker in accordance with the second embodiment of the present invention.

FIG. 5 is a sectional view of the speaker shown in FIG. 4.

FIG. 6 is a block diagram of a portable phone, an example of an electronic device in accordance with a third embodiment of the present invention.

FIG. 7 is a sectional view of an essential part of the portable phone shown in FIG. 6.

FIG. 8 is a plan view of a conventional speaker.

FIG. 9 is a sectional view of the speaker shown in FIG. 8.

### DETAIL DESCRIPTION OF PREFERRED EMBODIMENTS

### Exemplary Embodiment 1

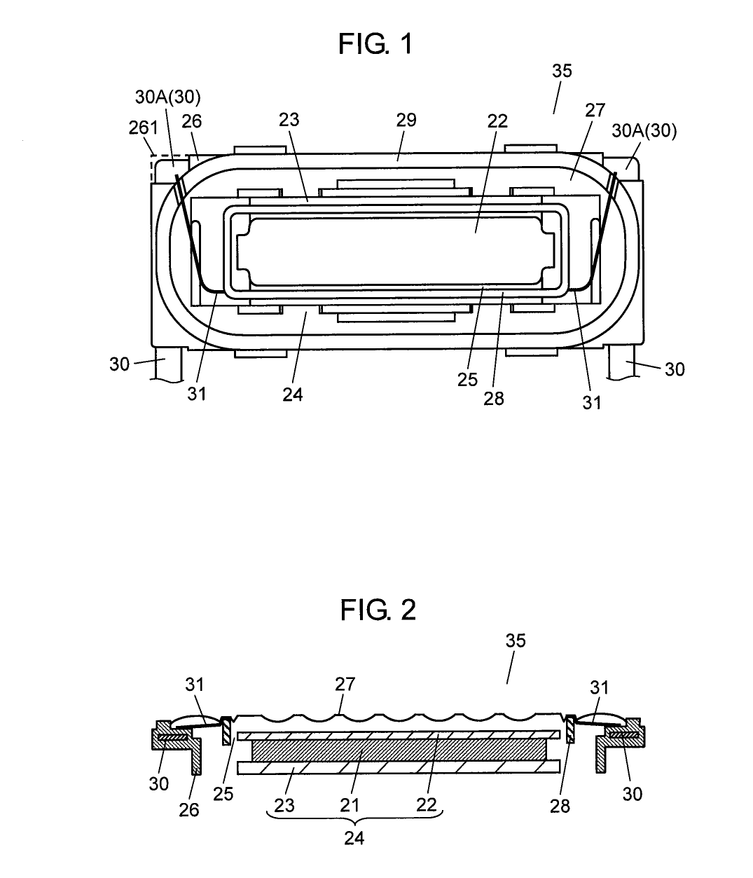

FIG. 1 and FIG. 2 are a plan view and a sectional view of a speaker in accordance with the first embodiment of the present invention. Speaker 35 is a small speaker to be mounted to a portable electronic device such as a portable phone. Speaker 35 comprises the following structural elements: magnetic circuit 24 including magnet 21;

frame 26; diaphragm 27; voice coil 28; and terminals 30. Diaphragm 27 is made of transparent material, so that the plan view cannot show it but sees through what is below diaphragm 27.

Magnetic circuit 24 of inner magnet type is formed by coupling magnet 21 onto yoke 23, and coupling upper plate 22 onto magnet 21. Frame 26 is made of resin, and includes yoke 23 and terminals 30 therein through insert-molding. In other words, frame 26 is coupled to magnetic circuit 24, and terminals 30 are coupled to frame 26 by insert-molding.

Frame 26 has opening 29, and diaphragm 27 is bonded to the rim of opening 29. Cut-away sections 261 are formed at parts of an outer shape of frame 26. Terminals 30 have protruding sections 30A protruding from cut-away sections 261. To be more specific, each of cut-away sections 261 is provided at respective one of corners of the outer shape of frame 26. Protruding sections 30A are disposed outside diaphragm 27 viewed from the top.

Voice coil 28 includes lead wires. 31 connected to diaphragm 27. Parts of voice coil 28 are disposed at magnetic gap 25 formed somewhere in magnetic circuit 24. Lead wires 31 are routed to protruding sections 30A of terminals 30 and coupled thereto respectively. Each of junctions between each of protruding sections 30A and each of lead wires 31 can be protected, when necessary, by applying reinforcing agent thereto.

An outer shape formed of frame 26 and protruding sections 30A of terminals 30 forms a rectangle or a square viewed from diaphragm 27 side. In other words, frame 26 forms a rectangle or a square of which outer shape is cut away at two corners, thereby forming two cut-away sections 261. Each terminal 30 protrudes from a side wall of cut-away section 261 such that it can stay within an outer shape of speaker 35. The word of rectangle or square used in this paper includes a rectangle or a square of which corners are R-chamfered or Line-chamfered.

Terminal 30 has the other end section opposite to protruding section 30A and this opposite end section forms a spring terminal for feeding power to the electronic device, e.g. a portable phone. Not to mention, this opposite end section can be eliminated, and protruding section 30A can be used, besides its original purpose, for feeding power to the electronic device.

Each of protruding sections 30A can be provided at respective one of the two corners on the outer shape, i.e. a rectangle or a square as shown in FIG. 1, and this location advantageously produces a great effect on downsizing the speaker. On top of that, in the case of speaker 35 having a rectangular outer shape, the outer shape of diaphragm 27 preferably forms a shape of racetrack. In the case of speaker 35 having a square outer shape, the outer shape of diaphragm 27 preferably forms a circle. Use of one of these shapes allows providing the junction between terminal 30 and lead wire 31 at a place where no diaphragm 27 exists, so that this structure allows further enhancing the effect on downsizing the speaker.

In the case where diaphragm 27 takes an outer shape of a rectangle or a square, four corners of diaphragm 27 are somewhat R-chamfered or Line-chamfered in order to improve the amplitude characteristics of diaphragm 27. Considering this structure, the placement of terminals 30 at the two corners of the rectangle or the square produces a great advantage. When these two corners stay inside the outer shape, i.e. rectangle or square, of speaker 35, they never interfere with the mounting of speaker 35 to the electronic device. The two corners out of four corners can be chosen without restraint.

The junction between lead wire 31 of voice coil 28 and protruding section 30A of terminal 30 preferably stay within the total height of frame 26. This structure allows speaker 35 to be thinner free from needless thickness.

Lead wire 31 of voice coil 28 is coupled to terminal 30 preferably by soldering, so that the speaker can be assembled with not massive but simple equipment. If the binding member, i.e. the solder, somewhat bulges, each protruding section 30A which forms a part of the junction with lead wire 31 is placed outside a periphery of diaphragm 27, and it protrudes from a side wall of frame 26. The dimensions of bulging solder can fall within the total height of frame 26 because no other components exist there.

Lead wire 31 and terminal 30 are preferably joined together by welding or thermo-compressing, which can reduce an amount of material, e.g. solder. As a result, the productivity can be improved and a conduction failure, e.g. tunnel soldering, can be avoided.

The soldering, welding, or thermo-compressing involves heat generation; however, since protruding section 30A protrudes from the side wall of frame 26, no other components exist around the junctions of lead wires 31. The heat generation thus does not adversely affect other components, and its influence to frame 26 can be minimized.

As discussed above, this first embodiment provides the junction between terminal 30 and lead wire 31 of voice coil 28 outside the periphery of diaphragm 27. This structure allows excluding each thickness of the following components from the total height of speaker 35: such as the material thickness of terminals 30, the outer diameter of lead wires 31, the material thickness of bonding agent, e.g. solder, for joining these components, the material thickness of the reinforcing agent applied to the junctions of lead wires 31. The thickness of speaker 35 can be thus reduced by the dimensions of those components disposed outside the periphery of diaphragm 27.

On top of that, protruding sections 30A of terminals 30 protrudes from the side wall of cut-away section 261, which is formed by cutting away a part of the outer form of frame 26, such that protruding sections 30A can stay within the outer shape of speaker 35. Protruding section 30A thus formed is connected with lead wire 31 of voice coil 27. This structure allows the outer dimensions of speaker 35 viewed from diaphragm 27 side not to stick out from the original shape of speaker 35, i.e. rectangle or square. Speaker 35 can be thus mounted appropriately to the electronic device with ease.

Terminals 30 are coupled to frame 26 by insert-molding, which improves the productivity and also the reliability of junctions between frame 26 and terminals 30. The junction between terminal 30 and lead wire 31 is disposed outside the periphery of diaphragm 27. This structure allows preventing foreign matters to enter magnetic gap 25 formed inside of the periphery of diaphragm 27. The foreign matters include scraps of solder and weld, or the reinforcing agent applied to the junctions of lead wires 31. Defects of the gap can be thus reduced.

### Exemplary Embodiment 2

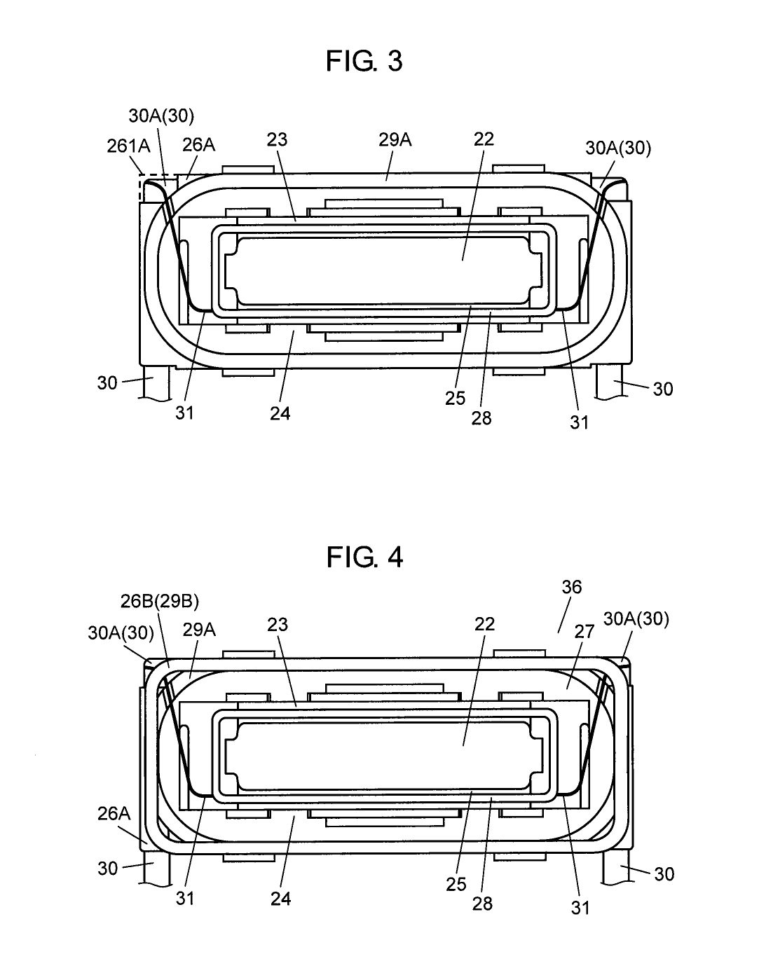

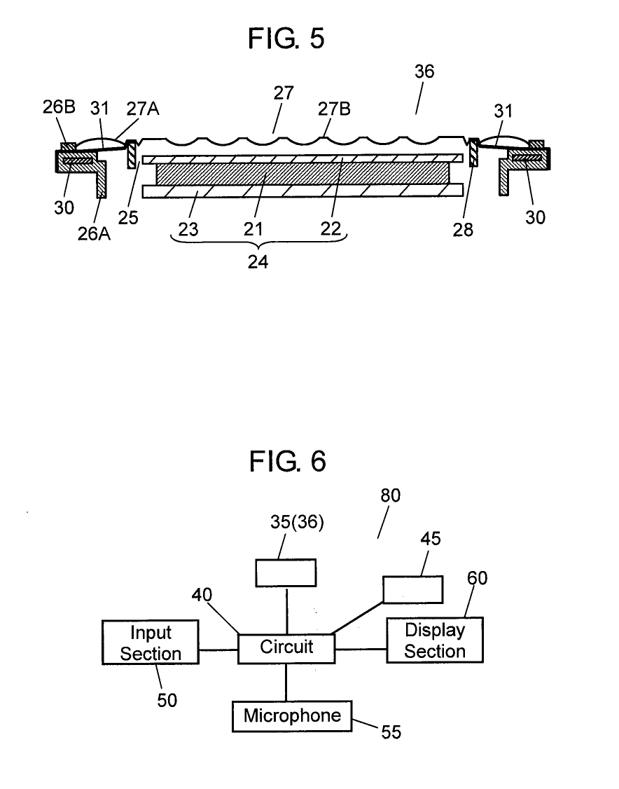

FIG. 3 is a plan view of a speaker in accordance with the second embodiment of the present invention, and this speaker is in progress of assembly. FIG. 4 is a plan view of the completely assembled speaker shown in FIG. 3. FIG. 5 is a sectional view of the speaker shown in FIG. 4.

Speaker 36 in accordance with this second embodiment differs from speaker 35 of the first embodiment in employing a frame formed of first frame section 26A and second frame section 26B instead of frame 26.

To be more specific, the frame includes first frame section 26A and second frame section 26B. First frame section 26A includes first opening 29A and is coupled to magnetic circuit 24, and second frame section 26B includes second opening 29B larger than first opening 29A and is coupled to first frame section 26A. An outer shape of second frame section 26B is the same as or smaller than that of speaker 36. Diaphragm 27 is coupled to a rim of second opening 29B of second frame section 26B.

As shown in FIG. 3, cut-away sections 261A made of resin are formed at parts of an outer shape of first frame section 26A. This is similar to frame 26 of the first embodiment. Terminals 30 are coupled to first frame section 26A by insert-molding. In other words, first frame section 26A has two cut-away sections 261A formed by cutting away two corners of the rectangle or square. Protruding sections 30A of terminals 30 protrude from a side wall of cut-away sections 261A such that it can stay within the outer shape of speaker 36. Lead wires 31 of voice coil 28 are respectively routed to and connected to protruding sections 30A provided outside magnetic circuit 24. To be more specific, each end of lead wires 31 are connected to a vicinity of the outer shape of protruding sections 30A respectively at a place outside first frame section 26A.

Second frame section 26B is made of resin as first frame section 26A is. However, second frame section 26B can be made of rubber or elastomer, the same material forming an edge of diaphragm 27, in the case of being integrated with the edge of diaphragm 27 described later. In the case of requiring rigidity, second frame section 26B can be made of metal, e.g. aluminum.

Basic structures other than what are discussed above remain unchanged from those of speaker 35. To be more specific, ends of terminals 30 opposite to protruding sections 30A form a spring terminal for feeding power to the electronic device. However, protruding sections 30A per se can be used as power feeding terminals to the electronic device. Each of the junctions between each of the protruding sections 30A and each of lead wires 31 can be protected, when necessary, by applying reinforcing agent thereto. Connection of lead wire 31 to protruding section 30A in the structure discussed above eventually produces an advantage similar to that of the first embodiment.

As shown in FIG. 4, second frame section 26B is bonded onto a top face of first frame section 26A and along a vicinity of the outer shape of speaker 36 such that a vibrating area of diaphragm 27 can be expanded. Diaphragm 27 is joined to a rim of the opening of second frame section 26B such that it can cover a part of protruding section 30A. The dimensions of second frame section 26B are minimized for reducing the thickness of speaker 36. This structure allows maximizing the area of diaphragm 27 comparing with the first embodiment where diaphragm 27 is directly coupled to first frame section 26A. As a result, a sound pressure level of speaker 36 can be improved.

Protruding sections 30A are formed respectively at two corners of first frame section 26A forming the rectangle or square. In the case of speaker 36 taking an outer shape of a rectangle, it is preferable that second opening 29B and diaphragm 27 also form rectangles. In the case of speaker 36 taking an outer shape of a square, it is preferable that second opening 29B and diaphragm 27 also form squares. This structure allows downsizing the speaker while its sound pressure level can be improved.

Any two corners can be chosen out of the four corners available as is done in the first embodiment. The junction between terminal 30 and lead wire 31 of voice coil 28 stays within the total height of first frame section 26A, so that a needless thickness can be eliminated advantageously for reducing the thickness of the speaker. To be more specific, in the case of second frame section 26B having the same outer shape as speaker 36, lead wire 31 can be routed through the space between second frame section 26B and protruding section 30A and then connected to protruding section 30A. In the case of second frame section 26B having a smaller outer shape than speaker 36, lead wire 31 can be connected to a stick-out portion of protruding section 30A from the outer shape of first frame section 26A. In this case, the junction between lead wire 31 of voice coil 28 and terminal 30 should stay within the total height of first and second frame sections 26A and 26B.

As shown in FIG. 5, diaphragm 27 includes edge 27A at the outer rim and an inside portion 27B preferably made of different material from that of edge 27A. Edge 27A and inside portion 27B employ the materials respectively satisfying their required specifications so that the sound pressure level can be further improved and the reproducible bandwidth can be widened. This structure is applicable also to the first embodiment. As discussed previously, second frame section 26B can be integrated with edge 27A of diaphragm 27 for improving the productivity.

For instance, edge 27A of diaphragm 27 is made of elastomer resin excellent in flexibility, while inside portion 27B is made of resin excellent in rigidity. This structure allows improving the sound pressure level and widening the reproducible bandwidth. On top of that, second frame section 26B and edge 27A of diaphragm 27 are unitarily molded with the same elastomer resin that is used for forming edge 27A and excellent in flexibility, then the productivity of the speaker having such characteristics can be improved.

### Exemplary Embodiment 3

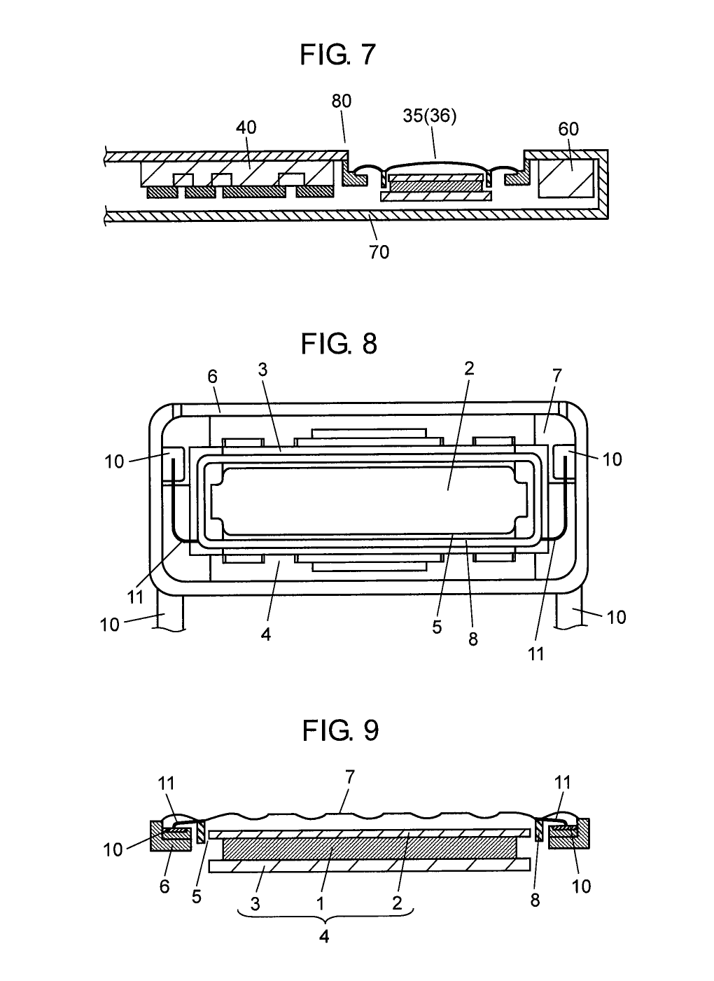

An electronic device to which speaker 35 is mounted on is demonstrated hereinafter with reference to FIGS. 6 and 7. FIG. 6 is a block diagram of a portable phone, an example of the electronic device in accordance with this embodiment. FIG. 7 is a sectional view of an essential part of the portable phone.

As shown in FIG. 6, portable phone 80 includes speakers 35 and 45, input section 50 for accepting input operations, microphone 55, display section 60 formed of, e.g. liquid crystal, and circuit 40 for driving at least speaker 35.

Circuit 40 receives an input from input section 50, and then displays the input or incoming call information on display section 60. During the operation of phone 80, circuit 40 receives an audio input and reproduces a message from a transmitter through speaker 45. On top of that, circuit 40 drives speaker 35 for producing an arrival tone. Speaker 45 can be the same as or different from speaker 35.

As shown in FIG. 7, speaker 35, circuit 40, and display section 60 are mounted inside housing 70, and form an essential part of portable phone 80. This structure allows reducing the thickness of speaker 35 while the portable phone, an example of the electronic device to which speaker 35 is mounted, can be downsized as well as its thickness can be reduced. On top of that, the productivity can be increased and the defective ratio can be lowered, so that the performance and the quality of the electronic device can be advantageously improved.

Speaker 36 can replace speaker 35. In this case, a higher sound pressure can be expected in addition to the downsizing and the reduction in thickness of the electronic device.

In this embodiment, a portable phone, i.e. a mobile communication device, is taken as an example of the electronic devices; however, the present invention is not limited to this example, and the electronic device can be a portable game device, portable navigation device, or a video device such as a television receiver. In other words, the present invention is applicable to any electronic devices to which speaker 35 can be mounted.

As discussed above, speaker 35 or 36 includes magnetic circuit 24 having magnet 21, frame 26 or the frame formed of first frame section 26A and second frame section 26B, diaphragm 27, voice coil 28, and terminals 30.

Frame 26 includes opening 29 and is coupled to magnetic circuit 24 and made of resin. In other words, frame 26 includes a resin portion coupled to magnetic circuit 24. In the case of employing the frame formed of first frame section 26A and second frame section 26B, second frame section 26B includes second opening 29B, and first frame section 26A, which is made of resin, is coupled to magnetic circuit 24. In other words this frame includes an opening, i.e. second opening 29B, and a resin portion, i.e. first frame section 26A, coupled to magnetic circuit 24.

Diaphragm 27 is coupled to a rim of opening 29 or a rim of second opening 29B. Voice coil 28 includes lead wires 31 and is coupled to diaphragm 27. A part of voice coil 28 is disposed at magnetic gap 25 provided somewhere in magnetic circuit 24. Terminal 30 is coupled to the frame by insert-molding.

An outer shape, viewed from diaphragm 27 side and formed by the frame and terminals 30, is either one of a rectangle or a square, and cut-away sections 261 or cut-away sections 261A are provided to the frame at corners of the outer shape of the resin portion. Terminals 30 include protruding sections 30A that protrude from cut-away section 261 or 261A, and lead wires 31 of voice coil 28 are connected to protruding sections 30A. The foregoing structure allows reducing the thickness of speaker 35 or 36.

### INDUSTRIAL APPLICABILITY

The present invention is applicable to speakers required to be thinner and small electronic devices, e.g. a portable phone mounted with the speaker.

### DESCRIPTION OF REFERENCE MARKS

21 magnet
22 upper plate
23 yoke
24 magnetic circuit
25 magnetic gap
26 frame
26A first frame section
26B second frame section
27 diaphragm
27A edge
27B inside portion
29 voice coil
29A opening
29A first opening
29B second opening
30 terminal
30A protruding section
31 lead wire
35, 36, 45 speaker
40 circuit
50 input section
55 microphone
60 display section
70 housing
80 portable phone
261, 261A cut-away section

1. A speaker comprising:
a magnetic circuit having a magnet;
a frame including a resin portion coupled to the magnetic circuit and having an opening;
a diaphragm coupled to a rim of the opening of the frame;
a voice coil including a lead wire and coupled to the diaphragm, a part of the voice coil being disposed at a magnetic gap provided in the magnetic circuit; and
a terminal coupled to the frame by insert-molding,
wherein an outer shape of the speaker, viewed from the diaphragm side, is formed by the frame and the terminal, and the outer shape of the speaker is one of a rectangle and a square,
wherein a cut-away section is provided in the frame at a corner of an outer shape of the resin portion, and the terminal includes a protruding section that protrudes from the cut-away section, and
wherein the lead wire of the voice coil is connected to the protruding section of the terminal.

2. The speaker of claim 1, wherein the frame is molded into one body with resin.

3. The speaker of claim 2, wherein the outer shape of the speaker is a rectangle, and the diaphragm has an outer shape of a race track.

4. The speaker of claim 2, wherein the outer shape of the speaker is a square, and the diaphragm has an outer shape of a circle.

5. The speaker of claim 1, wherein a junction between the lead wire of the voice coil and the protruding section of the terminal stays within a total height of the frame.

6. The speaker of claim 1, wherein the frame includes a first frame section and a second frame section, the first frame section being coupled to the magnetic circuit and having a first opening, the second frame section having a second opening greater than the first opening, the second frame section having an outer shape smaller than an outer shape of the speaker,
wherein the first frame section is the resin portion where the cut-away section is formed at a part of an outer shape of the resin portion, and the terminal is coupled to the first frame section by insert-molding, and
wherein the diaphragm is coupled to a rim of the second opening of the second frame section.

7. The speaker of claim 6, wherein the outer shape of the speaker is a rectangle, and the diaphragm has an outer shape of a rectangle.

8. The speaker of claim 6, wherein the outer shape of the speaker is a square, and the diaphragm has an outer shape of a square.

9. The speaker of claim 6,
wherein the diaphragm includes an edge on its outer periphery and an inside portion made of a material different from that of the edge, and
wherein the second frame section and the edge of the diaphragm are integrated into one body.

10. The speaker of claim 1, wherein the diaphragm includes an edge on its outer periphery and an inside portion made of a material different from that of the edge.

11. The speaker of claim 1, wherein the lead wire of the voice coil and the protruding section of the terminal are coupled together by soldering.

12. The speaker of claim 1, wherein the lead wire of the voice coil and the protruding section of the terminal are coupled together by welding.

13. The speaker of claim 1, wherein the lead wire of the voice coil and the protruding section of the terminal are coupled together by thermo-compressing.

14. An electronic device comprising:
the speaker as defined in claim 1; and
a circuit for driving the speaker.

15. A portable phone comprising:
the speaker as defined in claim 1;
an input section for accepting an input operation;
a microphone;
a display section; and
a circuit for driving at least the speaker.
